(19) United States
(12) Patent Application Publication
(10) Pub. No.: US 2014/0212127 A1
(43) Pub. Date: Jul. 31, 2014

(54) DEVICE ALLOWING INDEPENDENT TESTING OF DUAL CAMERA MODULE

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: WEI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/931,550

(22) Filed: Jun. 28, 2013

(30) Foreign Application Priority Data
Jan. 31, 2013 (CN) 2013100380580

(51) Int. Cl. G03B 17/02

(52) U.S. Cl. CPC G03B 17/02
USPC 396/542

(57) ABSTRACT

A dual camera module includes a first flexible printed circuit board (FPCB) with a first camera module, and a second FPCB with a second camera module. The first FPCB includes a first connector and an external connector electrically connected to the first connector and the second FPCB includes a second connector connected to the first connector. The geometry of the placement of the camera modules, and the manner of connection, allows each camera module to be tested independently before being tested together, thus improving the dual camera module's overall rate of passing quality control.

### BACKGROUND

1. Technical Field

The present disclosure relates to imaging devices and, particularly, to a dual camera module having two camera modules.

2. Description of Related Art

Dual camera modules generally include a flexible printed circuit board (FPCB) and two camera modules electrically positioned on the FPCB. During reliability testing, the reliability of the dual camera module will be influenced by any adverse characteristics of a single one of the camera modules, which results in the qualification rate of the dual camera module being lower.

Therefore, it is desirable to provide a dual camera module, which can overcome the limitations described.

### BRIEF DESCRIPTION OF THE DRAWINGS

FIG. 1 is a schematic view of a dual camera module in accordance with an exemplary embodiment.

FIG. 2 is an isometric, exploded, and schematic view of the dual camera module of FIG. 1.

FIG. 3 is similar to FIG. 2, but viewed from another angle.

### DETAILED DESCRIPTION

Embodiments of the disclosure will be described with reference to the drawings.

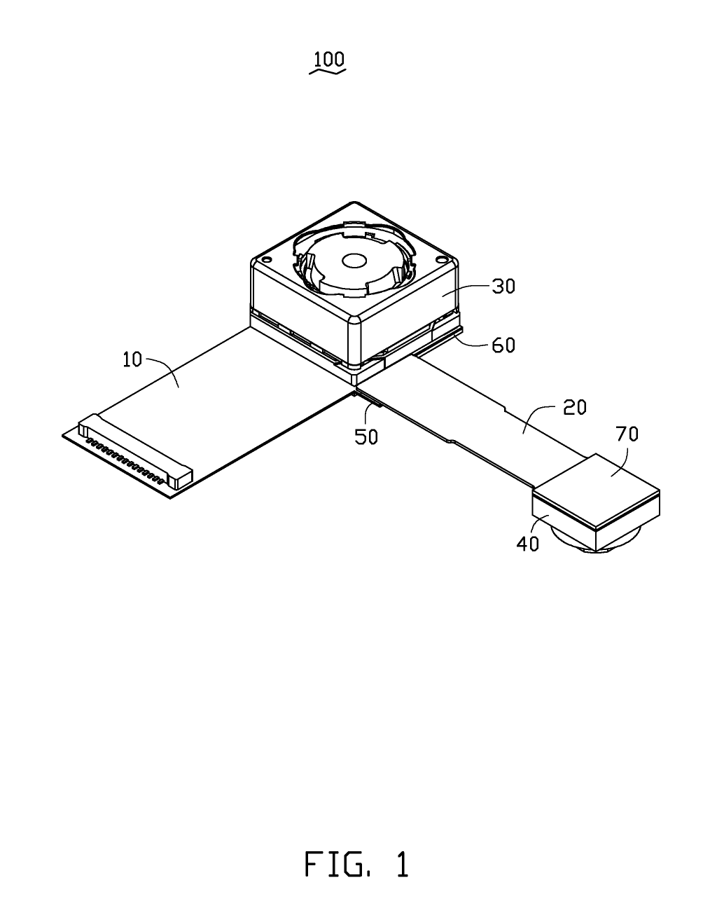

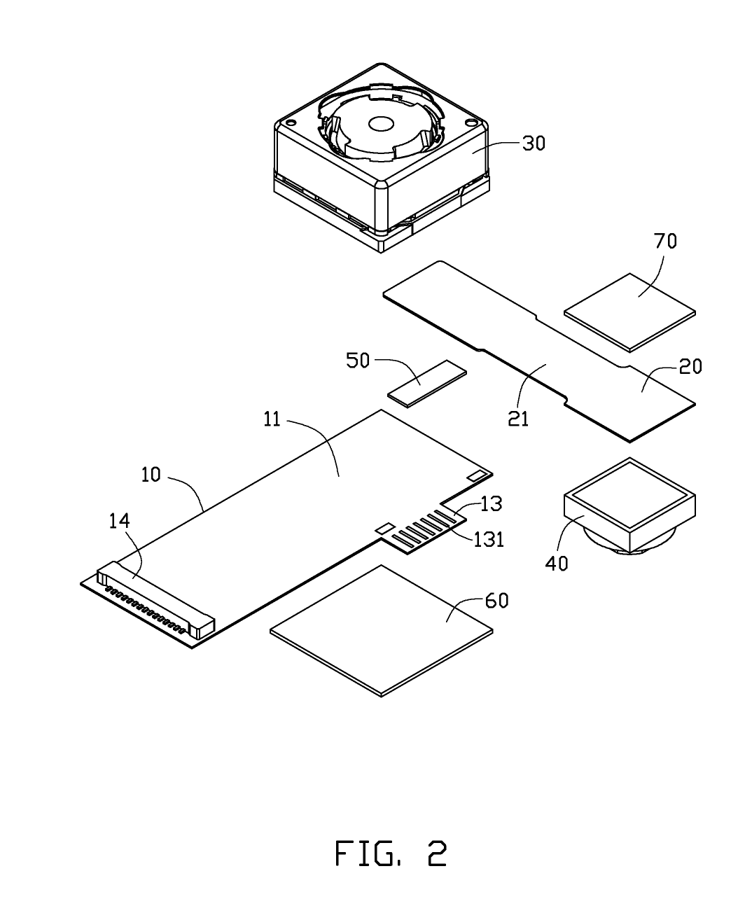

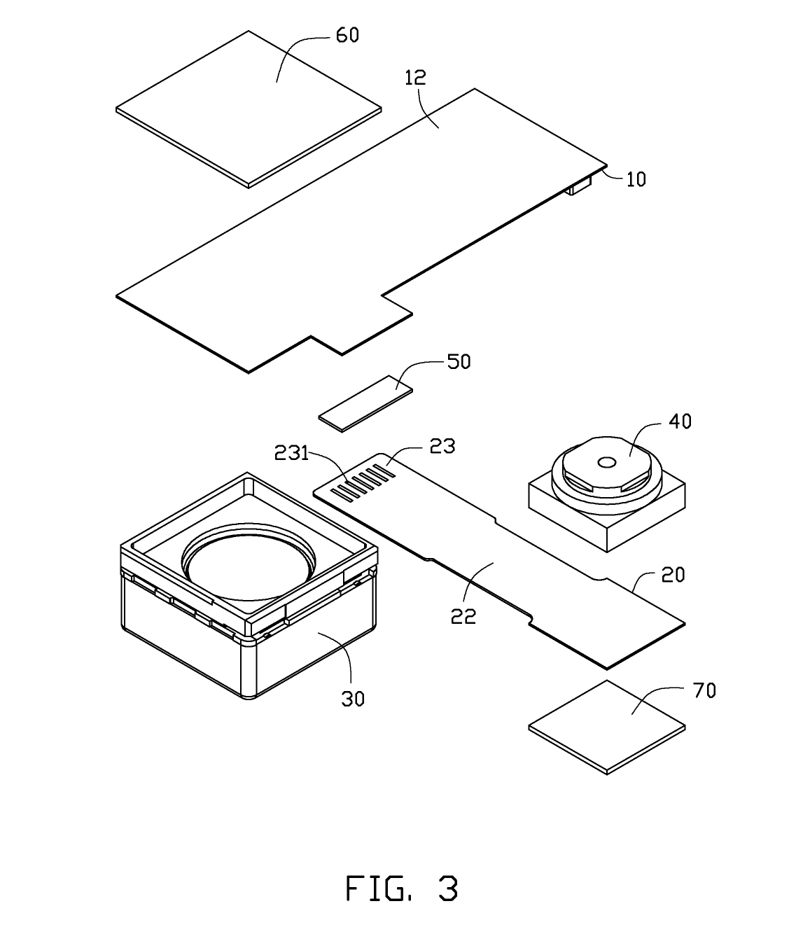

FIGS. 1-3 show a dual camera module 100, according to an exemplary embodiment. The dual camera module 100 includes a first flexible printed circuit board (FPCB) 10, a second FPCB 20, a first camera module 30, a second camera module 40, a conductive film 50, a first stiff board 60, and a second stiff board 70. The dual camera module 100 is used in an electrical device (not shown).

The first FPCB 10 is rectangular and has a long side and a short side. The first FPCB 10 includes a first upper surface 11 and a first lower surface 12 opposite to the first upper surface 11. The first FPCB 10 has a first connector 13 and an external connector 14 electrically connected to the first connector 13. The first connector 13 is located at the long side of the first FPCB 10, and the second connector 14 is located at the short side of the first FPCB 10. The first connector 13 includes a number of first pads 131, and the first pads 131 are positioned on the first upper surface 11 and arranged along the long side.

The second FPCB 20 includes a second upper surface 21 and a second lower surface 22 opposite to the second upper surface 21. The second FPCB 20 has a second connector 23. The second connector 23 is located at a short side of the second FPCB 20. The second connector 23 includes a number of second pads 231, and the second pads 231 are positioned on the second lower surface 22 and arranged along the short side.

The first camera module 30 is positioned on the first upper surface 11 of the first FPCB 10, and is adjacent to the first connector 13. The first connector 13 extends from one side of the first camera module 30, which largely protects the first connector 13 from incidental distortion or bending forces. The first camera module 30 is electrically connected to the external connector 14.

The second camera module 40 is positioned on the second lower surface 22 of the second FPCB 20, and is distant from the second connector 23. The second camera module 40 is electrically connected to the second connector 23.

In the embodiment, the first camera module 30 and the second camera module 40 each include a lens barrel and an image sensor. The first camera module 30 and the second camera module 40 are configured for capturing images.

The conductive film 50 is an anisotropic conductive film, and is made of resin and conductive particles. The conductive film 50 is electrically conductive along a direction perpendicular to an extending direction thereof and is electrically non-conductive along a direction parallel with the extending direction thereof.

The first stiff board 60 is made of metal, and is plate-shaped. The first stiff board 60 is positioned on the first lower surface 12 of the first FPCB 10. The first stiff board 60 is below the first camera module 30. In the embodiment, the first stiff board 60 is adhered on the first FPCB 10 by glue.

The second stiff board 70 is made of metal, and is plate-shaped. The second stiff board 70 is positioned on the second upper surface 21 of the second FPCB 20. The second stiff board 70 is below the second camera module 40. In the embodiment, the second stiff board 70 is adhered on the second FPCB 20 by glue.

During assembly, the conductive film 50 is adhered between the first connector 13 and the second connector 23. The first pads 131 of the first connector 13 are electrically connected to the second pads 231 of the second connector 23 when the conductive film 50 is hot pressed. The first camera module 30 and the second camera module 40 face two opposite directions. The second camera module 40 is electrically connected to the external connector 14 via the first connector 13 and the second connector 23.

During testing, the first FPCB 10 supporting the first camera module 30 is first tested and the second FPCB 20 supporting the second camera module 40 is then tested. If the first FPCB 10 supporting the first camera module 30 and the second FPCB 20 supporting the second camera module 40 pass quality control, the first FPCB 10 is connected to the second FPCB 20. If one of the first FPCB 10 supporting the first camera module 30 and the second FPCB 20 supporting the second camera module 40 is found to fail quality control, the failing element is changed.

As the first FPCB 10 supporting the first camera module 30 and the second FPCB 20 supporting the second camera module 40 are independently tested before electrically connecting to each other, the qualification rate of the dual camera module 100 is increased.

Particular embodiments are shown and are described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

1. A dual camera module, comprising:
a first flexible printed circuit board (FPCB) comprising a first connector and an external connector electrically connected to the first connector;
a first camera module positioned on the first FPCB, and electrically connected to the external connector;
a second FPCB comprising a second connector connected to the first connector; and
a second camera module positioned on the second FPCB and electrically connected to the second connector
wherein the first camera module and the second camera module face two directions opposite to each other.

2. The dual camera module of claim 1, wherein the first FPCB comprises a first upper surface and a first lower surface opposite to the first upper surface, the first connector comprises a plurality of first pads, and the first pads are positioned on the first upper surface.

3. The dual camera module of claim 2, wherein the first camera module is positioned on the first upper surface.

4. The dual camera module of claim 2, wherein the second FPCB comprises a second upper surface and a second lower surface opposite to the second upper surface, the second connector comprises a plurality of second pads, and the second pads are positioned on the second lower surface.

5. The dual camera module of claim 4, wherein the second camera module is positioned on the second lower surface.

6. The dual camera module of claim 4, comprising a conductive film, wherein the conductive film is adhered between the first connector and the second connector.

7. The dual camera module of claim 4, comprising a first stiff board and a second stiff board, wherein the first stiff board is positioned on the first lower surface of the first FPCB, and the second stiff board is positioned on the second upper surface of the second FPCB.

8. (canceled)

9. The dual camera module of claim 1, wherein the first connector extends from one side of the first camera module.
